(19) United States
(12) Patent Application Publication
(10) Pub. No.: US 2024/0241756 A1
(43) Pub. Date: Jul. 18, 2024

(54) RESTART PROCESSING OF AN APPLICATION MANAGER COMPONENT OF A DEVICE

(71) Applicant: INTERNATIONAL BUSINESS MACHINES CORPORATION, Armonk, NY (US)

(72) Inventors: Masakuni OKADA, Abiko-Shi (JP); Hayato UENOHARA, Funabashi-shi (JP); Seiya SHIMIZU, Yokohama-shi (JP)

(21) Appl. No.: 18/155,321

(22) Filed: Jan. 17, 2023

(51) Int. Cl. G06F 9/50

(52) U.S. Cl. CPC G06F 9/5033; G06F 9/5055

(57) ABSTRACT

An application manager component executing on a device obtains a request from an application to use a resource common to a plurality of applications. Based on obtaining the request, information to be used to rebuild status of the resource should it be determined that status rebuild of the resource is to be performed is provided to the application. Further, based on a restart of the application manager component, the information to be used to rebuild the status of the resource is obtained by the application manager component. The information is used to rebuild the status of the resource.

### BACKGROUND

One or more aspects relate, in general, to facilitating processing within a computing environment, and in particular, to improving restart processing within a device of the computing environment.

Certain computing environments include edge devices that provide specific functions for users. An edge device collects and processes data and is typically located close to the data that it is collecting. An edge device may run multiple applications and those applications use resources that are common to the applications (i.e., used by a plurality of applications). The types of resources depend, for instance, on the function(s) being provided by the applications and/or the edge device. For instance, if the edge device is a navigation system (e.g., of a vehicle), the resources, referred to as common resources, may include a universal serial bus (USB), a display, cameras, voice recognition system, etc. of the edge device.

In such environments, an application manager component, executing on the edge device, may manage requests from the multiple applications to use the common resources. For example, when an application, App-A, is playing sound via a speaker, the application manager component may reject a request from another application, App-B, which also wants to use a speaker. In another example, the application manager component may keep App-B waiting until App-A releases access rights or gives priority access to App-B. The application manager component keeps such status of the resource usage of the multiple applications and manages resource usage priority.

Since the application manager component is responsible for managing requests, actions are taken if the application manager component terminates or stops running. For example, if the application manager component unexpectedly stops, the applications being managed by the application manager component are stopped until the application manager component is restarted. This disruption of the applications is undesirable.

One solution to such disruption may include using redundant systems. For example, two instances of the application manager component may be executed, and those multiple instances share their states (data, information, etc.) via shared memory. In this case, one application manager component functions as the active management system and when it stops (e.g., unexpectedly), the other application manager component instance replaces it and becomes active. This solution, however, requires enough available memory and resources to keep two or more instances of the application manager component running.

Another solution may be to save the global state of resource usage into a persistent storage or file. For example, such system could have the participants of the system (i.e., application manager component and applications) exclusively update this file as a “single-point-of-truth” to keep track of resource usage state changes. However, this solution would impose a requirement on the application manager component and applications to know the format and update logic of this file and limits the system's capability to change or extend its format on fixes, enhancements, new resource additions and so on, because both the application manager component and the applications would need to be updated together for both to be able to process consistently under the new file format. This would require the applications to be stopped and restarted along with the application manager component on updates.

Based on the foregoing, disruptions resulting from the stopping or termination of an application manager component are to be minimized. Thus, restart processing of the application manager component is to be improved.

### SUMMARY

Shortcomings of the prior art are overcome, and additional advantages are provided through the provision of a computer-implemented method of facilitating processing within a computing environment. The computer-implemented method includes obtaining, by an application manager component executing on a device, a request from an application to use a resource common to a plurality of applications. Based on obtaining the request, information to be used to rebuild status of the resource should it be determined that status rebuild of the resource is to be performed, is provided to the application. The application manager component obtains, based on a restart of the application manager component, the information to be used to rebuild the status of the resource. The information is used to rebuild the status of the resource.

By providing the information to the application, the information remains available should there be a need for a rebuild of status relating to the information, such as based on a restart of the application manager component. This facilitates processing and minimizes the use of memory by enabling the rebuild without requiring additional resources, such as duplicate systems.

In one example, the information includes an identifier of the resource and usage information of the resource by the application. This information facilitates a rebuild of usage status of the resource. In one example, the information includes control data of the resource. The control data provides unique aspects of the resource for a particular application and facilitates a rebuild of usage status of the resource.

In one embodiment, based on the providing to the application the information, the information is stored in a repository of the application. By storing the information in the repository, the information is available to rebuild resource status. It enables applications to continue to run even if the application manager component stops and/or is restarted. This facilitates processing and minimizes the use of redundant resources.

In one embodiment, the obtaining by the application manager component the information to be used to rebuild the status of the resource includes obtaining the information based on a connect request of the application to the application manager component. If the application manager component stops or disconnects from the application, the application may request to connect and based thereon, provides the information to the application manager component enabling that component to rebuild status of the resource. This allows applications to continue running even if the application manager component stops and/or is restarted.

In one embodiment, the obtaining by the application manager component the request includes using an application manager component-side connection manager of the application manager component coupled to an application-side connection manager of the application to obtain the request from the application. This facilitates communication between the application and the application manager component.

In one example, the device is an edge device providing a function to a user, and the resource is related to the function. This allows processing to be performed close to the data and without requiring a large amount of resources.

In one embodiment, the content of the information is unknown to the application. Thus, the application is not responsible for understanding the content but yet is able to facilitate processing by storing the information and then providing the information to the application manager component for rebuilding status of the resource.

In one aspect, a request to use a resource common to a plurality of applications is sent from an application executing on a device to an application manager component. Based on sending the request, the application obtains access to the resource and information relating to the resource. A determination is made that the application manager component has been restarted. Based on determining that the application manager component has been restarted, the information is provided to the application manager component. The information is to be used to rebuild status of the resource. By obtaining the information and providing it to the application manager component, a rebuild of resource status is enabled. This allows the application to continue running even if the application manager component stops and/or is restarted.

In one embodiment, the information is stored in a repository of the application based on obtaining the information. This enables the application to hold the information in case it is needed by the application manager component for a rebuild of resource status.

In one embodiment, the application continues to run, based on a stopping of the application manager component. This facilitates processing by not disrupting the running of the application.

In one embodiment, the information held by the application is removed, based on termination of use of the resource by the application. This enables resources to be returned to the application and reduces the amount of memory or storage used to hold the information.

Computer systems and computer program products relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to incorporate and use one or more aspects of the present invention;

FIG. 2 depicts one example of an edge device of the computing environment of FIG. 1 to incorporate and use one or more aspects of the present invention;

FIG. 3 depicts one example of sub-modules of an application manager component restart module of FIG. 1, in accordance with one or more aspects of the present invention;

FIG. 4A depicts one example of application logic processing, in accordance with one or more aspects of the present invention;

FIG. 4B depicts one example of application programming interface handler processing, in accordance with one or more aspects of the present invention;

FIG. 5A depicts one example of application-side connection manager processing, in accordance with one or more aspects of the present invention;

FIG. 5B depicts one example of application manager component-side connection manager processing, in accordance with one or more aspects of the present invention;

FIG. 6A depicts one example of common resource manager processing, in accordance with one or more aspects of the present invention;

FIG. 6B depicts one example of information holder processing, in accordance with one or more aspects of the present invention;

FIG. 7A depicts one example of further details of application-side connection manager processing, in accordance with one or more aspects of the present invention;

FIG. 7B depicts one example of further details of common resource manager processing, in accordance with one or more aspects of the present invention;

FIG. 7C depicts one example of further details of information holder processing, in accordance with one or more aspects of the present invention;

FIG. 7D depicts one example of information collector processing, in accordance with one or more aspects of the present invention;

FIG. 8 depicts one example implementation of access right management, in accordance with one or more aspects of the present invention;

FIG. 9 depicts one example implementation of notification management, in accordance with one or more aspects of the present invention;

FIG. 10 depicts one example implementation of priority management, in accordance with one or more aspects of the present invention; and

FIGS. 11A-11B depict another example of a computing environment to incorporate and use one or more aspects of the present invention.

### DETAILED DESCRIPTION

In accordance with one or more aspects of the present invention, a capability is provided to facilitate processing within a computing environment. In one or more aspects, the capability includes facilitating restart processing of an application manager component on a device, such as an edge device of a computing environment. The restart processing may be used based on unexpected stopping (e.g., termination, ending, halting, pausing) of the application manager component and/or scheduled stopping and/or replacement of the application manager component.

In one or more aspects, the restart processing restarts the application manager component efficiently and facilitates synchronization of the application manager component with the running applications without a conflict of status for the resources common to the applications, referred to herein as common resources. Applications may be kept running, while the application manager component is restarted. One or more aspects of the restart processing improves processing within the computing environment by allowing applications to continue running while the application manager component is being restarted, quickly restarting the application manager component such that application requests are not delayed too long, automatically synchronizing with the running applications to facilitate processing, and minimizing memory requirements.

One or more aspects of the present invention are incorporated in, performed and/or used by at least one computing environment. As examples, the computing environment may be of various architectures and of various types, including, but not limited to: personal computing, client-server, distributed, network, virtual, emulated, partitioned, non-partitioned, cloud-based, quantum, grid, time-sharing, cluster, peer-to-peer, wearable, mobile, having one node or multiple nodes, having one processor or multiple processors, and/or any other type of environment and/or configuration, etc. that is capable of executing a process (or multiple processes) to perform restart processing of the application manager component and/or perform one or more other aspects of the present invention. Aspects of the present invention are not limited to a particular architecture or environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

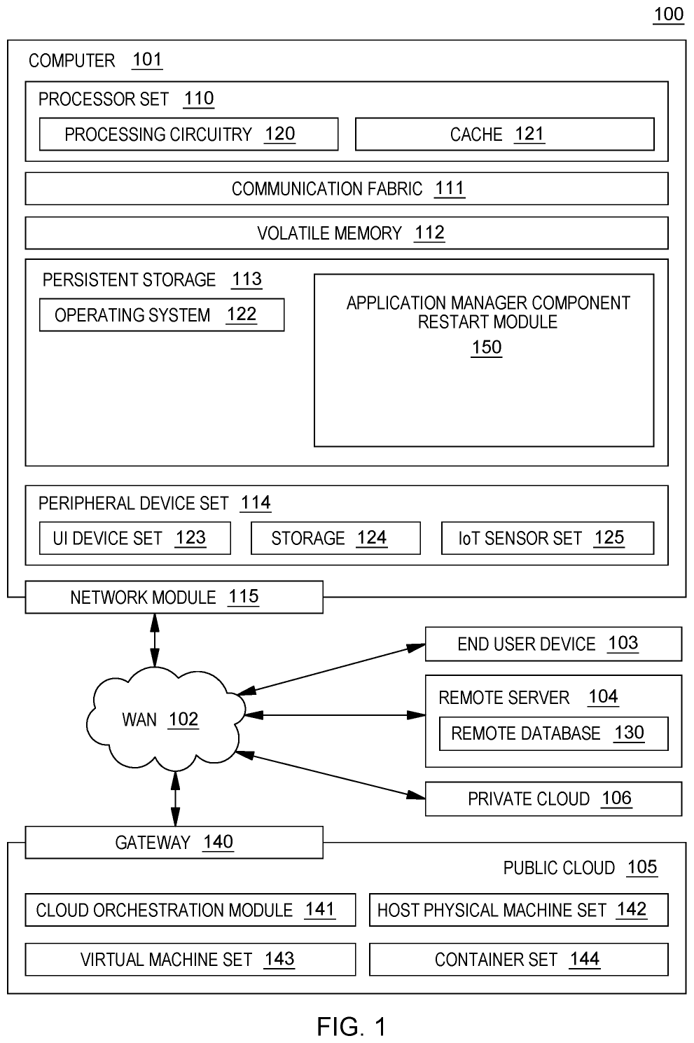

One example of a computing environment to perform, incorporate and/or use one or more aspects of the present invention is described with reference to FIG. 1. In one example, a computing environment 100 contains an example of an environment for the execution of at least some of the computer code involved in performing the inventive methods, such as application manager component restart code or module 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present invention. Other examples are possible. For instance, in one or more embodiments, one or more of the components/modules of FIG. 1 are not included in the computing environment and/or are not used for one or more aspects of the present invention. Further, in one or more embodiments, additional and/or other components/modules may be used. Other variations are possible.

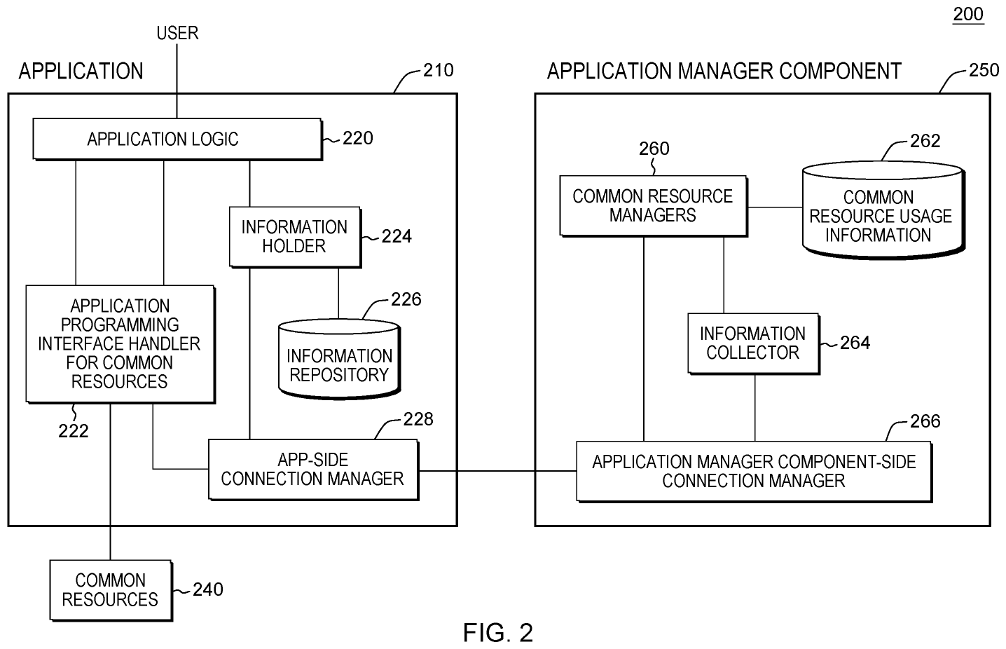

In one example, a component of the computing environment is or includes an edge device that collects and processes data in proximity to the data. Examples of an edge device include a navigation system (e.g., a vehicle navigation system), a connected home appliance, a connected manufacturing machine, or other types of systems/machines/devices, etc. that provide one or more functions to users. A component that is or includes an edge device may be, for instance, a computing device (e.g., a computer (e.g., computer 101, etc.), an end user device (e.g., end user device 103, etc.), a remote server (e.g., remote server 104, etc.), a processor of a processor set (e.g., processor set 110), a node of a processor of a processor set (e.g., processor set 110) and/or one or more other computing devices) and/or other components. Further details of an edge device are described with reference to FIG. 2.

Referring to FIG. 2, in one example, an edge device 200 includes an application or application side 210 and an application manager component or application manager component side 250. Application 210 includes, for instance, application logic 220 that uses one or more common resources 240, an application programming interface (API) handler for common resources 222, an information holder 224, an information repository 226 and an application (app)-side connection manager 228, each of which is further described herein.

Further, in one example, application manager component 250 includes one or more common resource managers 260, e.g., one for each common resource; common resource usage information 262; an information collector 264; and an application manager component-side connection manager 266, each of which is further described herein. An edge device may include additional, fewer and/or other sides/components/logic, etc. Many options are possible.

In accordance with one or more aspects of the present invention, to provide application manager component restart processing, an application manager component restart module (e.g., application manager component restart module 150) is employed, in one example. An application manager component restart module (e.g., application manager component restart module 150) includes, for example, various sub-modules to be used to perform the processing. The sub-modules are, e.g., computer readable program code (e.g., instructions) in computer readable media, e.g., storage (storage 124, persistent storage 113, cache 121, other storage, as examples). The computer readable media may be part of a computer program product and may be executed by and/or using one or more computing devices (e.g., one or more computers, such as computer(s) 101; one or more end user devices, such as end user device(s) 103; one or more servers, such as remote server(s) 104; one or more processors or nodes, such as processor(s) or node(s) of processor set 110; and/or processing circuitry, such as processing circuitry 120 of processor set 110; and/or other computing devices.) Additional and/or other computers, end user devices, servers, processors, nodes, processing circuitry and/or other computing devices may be used to execute one or more of the sub-modules and/or portions thereof. Many examples are possible.

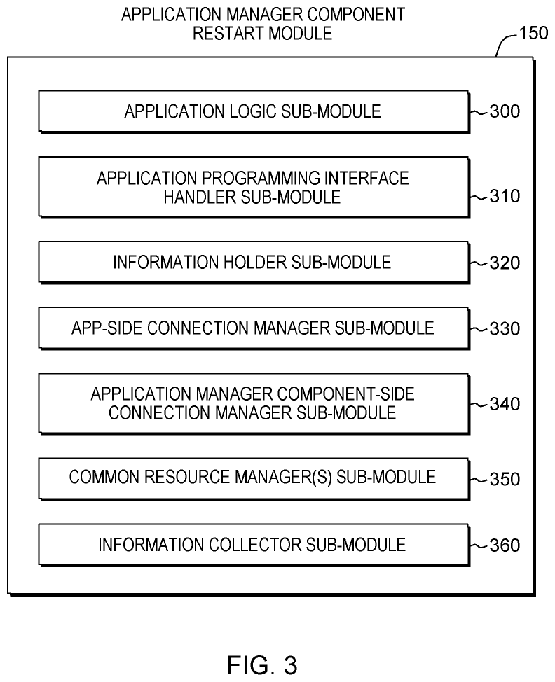

One example of application manager component restart module 150 is described with reference to FIG. 3. In one example, application manager component restart module 150 includes an application logic sub-module 300; an application programming interface (API) handler sub-module 310; an information holder sub-module 320; an application-side connection manager sub-module 330; an application manager component-side connection manager sub-module 340; a common resource manager(s) sub-module 350; and an information collector sub-module 360. Additional, fewer and/or other sub-modules may be provided and/or used in one or more aspects of the present invention.

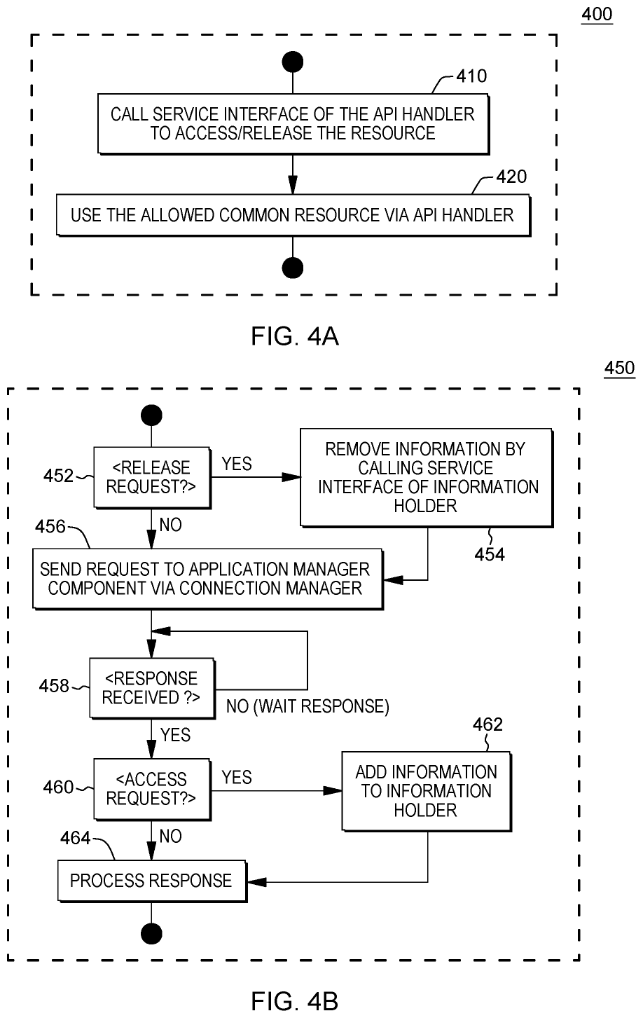

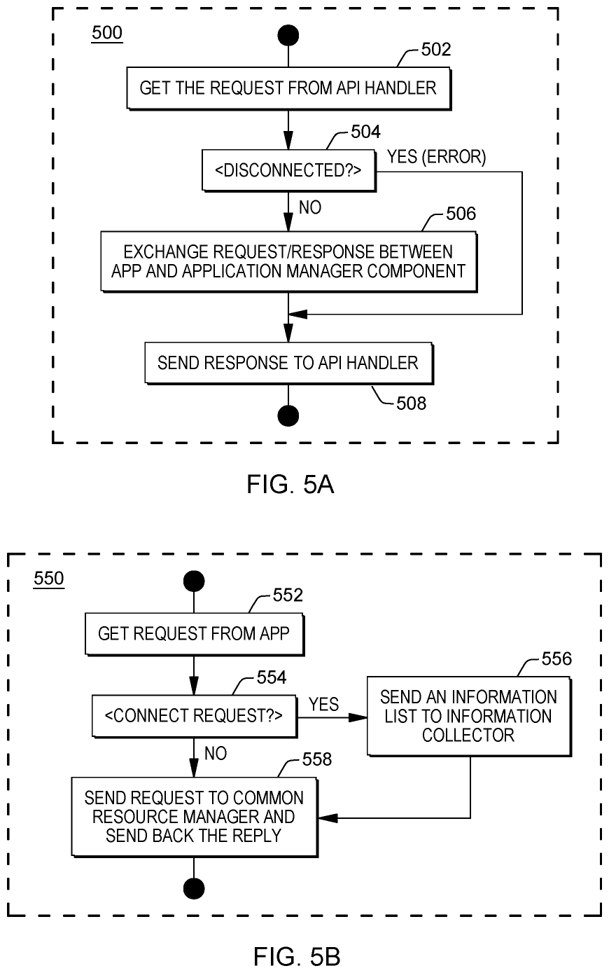

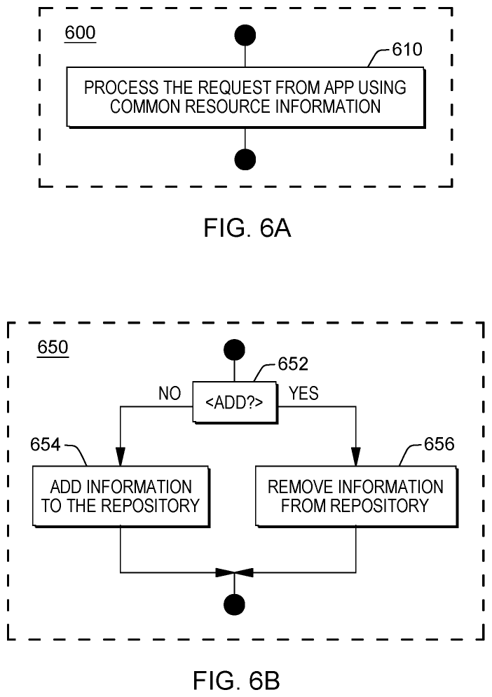

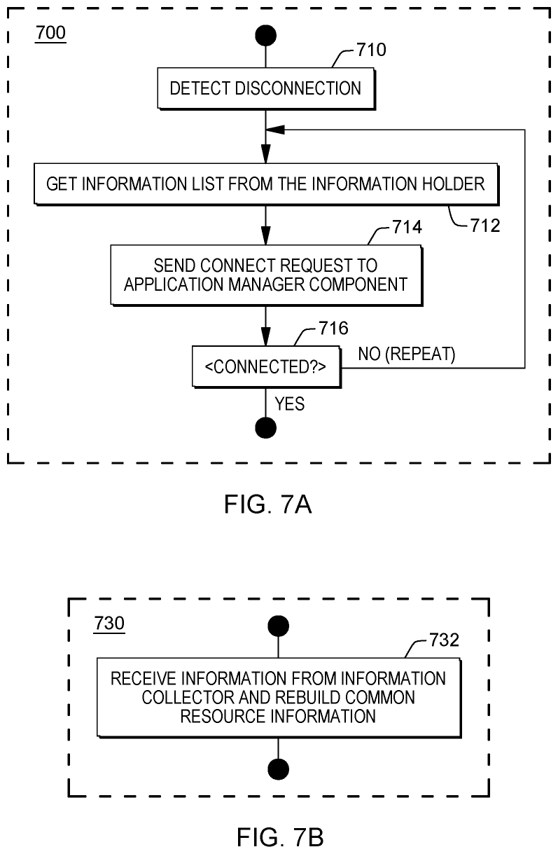

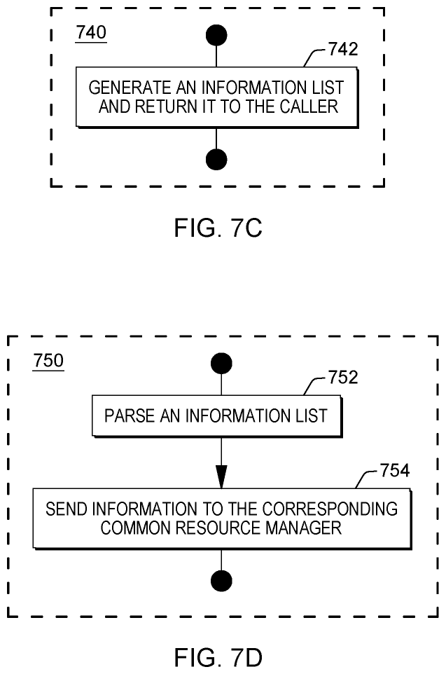

In one example, in one or more embodiments, one or more of the sub-modules are used in application manager component restart processing, aspects of which are described with reference to FIGS. 4A-7D. As examples, FIG. 4A depicts one example of an application logic process to facilitate restart processing; FIG. 4B depicts one example of an application programming interface handler for common resources process to facilitate restart processing; FIG. 5A depicts one example of an application-side connection manager process to facilitate restart processing; FIG. 5B depicts one example of an application manager component-side connection manager process to facilitate restart processing; FIG. 6A depicts one example of a common resource manager process to facilitate restart processing; FIG. 6B depicts one example of an information holder process to facilitate restart processing; FIG. 7A depicts one example of further details of an application-side connection manager process to facilitate restart processing; FIG. 7B depicts one example of further details of a common resource manager process to facilitate restart processing; FIG. 7C depicts one example of further details of an information holder process to facilitate restart processing; and FIG. 7D depicts one example of an information collector process to facilitate restart processing.

Each process used to perform the processing is executed, in one or more examples, by an edge device, which may be and/or included within, for instance, a computing device (e.g., a computer (e.g., computer 101, etc.), an end user device (e.g., end user device 103, etc.), a remote server (e.g., remote server 104, etc.), a processor of a processor set (e.g., processor set 110), a node of a processor of a processor set (e.g., processor set 110) and/or one or more other computing devices) and/or other components. Although example computing devices are provided, additional, fewer and/or other computing devices may be used for the processes/processing to perform application manager component restart processing. Various options are possible.

In one example, when a user performs an operation which is to access a common resource (e.g., of the edge device), the application logic (e.g., application logic 220) sends an access request to an application manager component (e.g., application manager component 250), and when access is allowed, the application logic accesses the relevant common resource. As an example, a request for a common resource from an application (e.g., application 210) is sent to an application manager component (e.g., application manager component 250) via an application programming interface handler for common resources (e.g., application programming interface handler for common resources 222). For a common resource, in one example, there is one application programming interface handler paired with a common resource manager (e.g., common resource manager 260) of the application manager component. For instance, an application programming interface handler for a universal serial bus is paired with a common resource manager for a universal serial bus. Although universal serial bus is provided as one example common resource, there may be many other common resources including, but not limited to, a display, cameras, speakers, screens, etc. Many options exist. Universal serial bus is only one example. Further, although in this example, there is a one-to-one pairing of handler to common resource manager, in other examples, there may be one handler for one or more common resource managers or one or more handlers for one manager, etc. Various examples are possible. A request and its response are exchanged via connection managers (e.g., app-side connection manager 228 and application manager component-side connection manager 266). One or more aspects of this processing is further described with reference to FIGS. 4A-4B and FIGS. 5A-5B.

Referring initially to FIG. 4A, a process 400 executed by application logic (e.g., application logic 220) of an application (e.g., application 210) calls 410 a service interface of an application programming interface handler (e.g., application programming interface handler for common resources 222) to access (or release, in another example) a common resource. The application programming interface handler for the particular common resource (e.g., corresponding application programming interface handler for common resources 222) processes the request, as described with reference to FIG. 4B, and based thereon, the common resource, if allowed, is used 420 by the application via the corresponding application programming interface handler (e.g., application programming interface handler for common resource 222).

One example of processing by the application programming interface handler for the particular common resource (e.g., corresponding application programming interface handler for common resource 222) is described with reference to FIG. 4B. As an example, a process 450 executed by the application programming interface handler for the particular common resource (e.g., corresponding application programming interface handler for common resource 222) determines 452 whether the request is a release request. If it is a release request, then process 450 initiates removal 454 of selected information of the common resource (e.g., information for rebuilding common resources) from a repository (e.g., information repository 226). For example, it calls a service interface of an information holder (e.g., information holder 224), which removes the selected information from the repository. Subsequent to calling the service interface or if the request is not a release request, process 450 sends 456 the request to an application manager component (e.g., application manager component 250) via, e.g., a connection manager (e.g., app-side connection manager 228).

Process 450 determines 458 whether a response was received from the application manager component (e.g., application manager component 250). If a response was not received, process 450 waits (at least until a prespecified condition is met—e.g., a predetermined amount of time, a threshold is met, other defined terminating condition, etc.). Otherwise, if a response is received, process 450 determines 460 whether the request is an access request. If it is an access request, process 450 at least initiates adding 462 the selected information for the common resource (e.g., information for rebuilding the common resource) to the repository (e.g., repository 226). For instance, it calls a service interface of the information holder (e.g., information holder 224) to add information regarding the common resource to the repository or it adds the information directly. The caller of the service and/or the application component adding (or removing, listing, obtaining, etc.) the selected information to the repository need not know the contents of the selected information. That is, as a response to the access request, selected information for the common resource (e.g., information for rebuilding the common resource) is sent to the application (e.g., application 210) and that information is added to the repository. Thereafter, or if the request is not an access request, process 450 processes 464 the response.

One example of a service interface for an information holder (e.g., information holder 224) is depicted below. This example is a Java® implementation; however, other programming languages may be used. Java and all Java-based trademarks and logos are trademarks or registered trademarks of Oracle and/or its affiliates. In this example, IRCR stands for information for rebuilding common resource, and it is the selected information of the common resource.
void addIRCR(IRCRData ircr);
   //Add an IRCR to the repository.
   //This interface is called when the API Handler gets the response of access request from the corresponding common resource manager.
   //ircr—The instance of IRCR which is sent with the response of request.
void removeIRCR(ResourceType type);
   //Remove an IRCR from the repository. Removed IRCR is identified by type.
   //This interface is called when the API Handler gets the request to release the resource from the Application Logic.
   //The caller (the API Handler for the resource) knows the type of resource but not the contents of the selected information.
IRCRList getIRCRList( )
   //Used by App-side Connection Manager to get current list of IRCRs.

As indicated, a request is sent from an application (e.g., application 210) to an application manager component (e.g., application manager component 250) via a connection manager (e.g., app-side connection manager 228). One example of application-side connection manager processing is described with reference to FIG. 5A. In one example, a process 500 executed by, e.g., an application-side connection manager (e.g., app-side connection manager 228) obtains 502 the request for the common resource from the application programming interface handler for the common resource (e.g., corresponding application programming interface handler 222). Process 500 determines 504 whether a connection between the application and the application manager component is disconnected. If there is a connection, process 500 exchanges 506 the request/response between application side 210 and application manager component side 250. For instance, the request is sent from the application (e.g., application 210) to the application manager component (e.g., application manager component 250) via an application-side connection manager (e.g., app-side connection manager 228). The request is received by an application manager component-side connection manager (e.g., application manager component-side connection manager 266). Further, a response is sent from application manager component 250 to application 210 via connection managers 266, 228. Process 500 sends 508 the received response to the application programming interface handler for the common resource (e.g., corresponding application programming interface handler 222).

However, if the connection is disconnected, process 500 indicates an error and an error response is provided to the application programming interface handler for the common resource (e.g., application programming interface handler 222).

One example of application manager component-side connection manager processing is described with reference to FIG. 5B. In one example, a process 550 executed by, e.g., an application manager component-side connection manager (e.g., application manager component-side connection manager 266) obtains 552 a request from the application (e.g., application 210) via, e.g., app-side connection manager 228. Process 550 determines 554 whether the request is a connect request. If it is a connect request, process 550 sends 556 an information list (e.g., an information for rebuilding common resources list) to an information collector (e.g., information collector 264). For instance, a list of the common resources used by the application is provided to the information collector (e.g., information collector 264). Thereafter, or if it is not a connect request, process 550 sends 558 the request to a common resource manager (e.g., common resource manager 260) corresponding to the requested common resource. Connection manager 266 obtains (e.g., receives, is provided, fetches, etc.) a reply from the corresponding common resource manager (e.g., common resource manager 260) and sends back the reply to the application via app-side connection manager 228.

As indicated, in one example, as part of the response/reply for an access request, selected information (e.g., information for rebuilding common resources) for the relevant common resource is sent to the application (e.g., application 210). For instance, a common resource manager assigned to the common resource (e.g., common resource manager 260), processes the request and generates the selected information if access to the resource is allowed. If access is rejected, the selected information for the relevant common resource is not generated. The generated selected information is sent back to the application as, e.g., a parameter of the response/reply to the request. This processing is depicted in FIG. 6A.

Referring to FIG. 6A, in one example, a process 600 executed by, e.g., a common resource manager of the requested common resource (e.g., common resource manager 260) processes 610 the request from the application (e.g., application 210) using common resource usage information (e.g., common resource usage information 262). If, for instance, the request is an access request and the access is allowed, the relevant common resource manager (e.g., common resource manager 260) generates the selected information, which is provided to the application and maintained there in case status (e.g., usage status of the common resource) is to be rebuilt (e.g., due to a stopping or restarting of the application component manager).

In one example, the selected information (e.g., the rebuild information for the common resource) includes a common part (C) and a unique part (U) so that each pair of application programming interface handler/common resource manager may define the information for its unique recovery processing. For example, the selected information for a universal serial bus may have a list of application identifiers to which the notification of universal serial bus device insertion/removal is sent, while the selected information for another common resource, such as a sound speaker, may have only one application identifier if the system allows only one application to access the sound speaker at once. Other examples are also possible. The unique format may be changed according to system implementations. For example, if the system allows an application to wait for access to end under use by another application for a sound speaker, the information for the sound speaker may have a list of application identifiers with its status (e.g., using, waiting, etc.) and, e.g., their access priorities. Other examples are also possible.

One example format for selected information is provided below:

| Item of Structure | C/U | Description |
|---|---|---|
| Application ID | C | ID of Application which uses |
| | | the common resource |
| Common Resource type ID | C | A distinguishable ID is assigned to each type |
| | | of common resource. For example, 1 for |
| | | USB, 2 for Microphone, 3 for Voice |
| | | Recognition System, etc. |
| Version number | C | Version of the selected information format. A |
| | | version number is used to provide upper |
| | | compatibility of selected information format. |
| | | A version number may differ depending on |
| | | the type of common resource. For example, |
| | | when the format of control data of selected |
| | | information for, e.g., a USB is updated while |
| | | others are not updated, the version number of |
| | | the USB (type ID = 1) becomes, e.g., 1.1 while |
| | | the version number of others are still, e.g., 1.0. |
| Sequence Index | C | Information that shows in what order selected |
| | | information is generated. This information is |
| | | used to support a prioritized order of resource |
| | | usage. |
| Control Data | U | Control data differs depending on the type of |
| | | common resource. A common resource |
| | | manager (existing in the application manager |
| | | component side) defines the format so that it |
| | | facilitates rebuilding the common resource |
| | | usage information. |

Some of the fields are further discussed below.

The pair of application programming interface handler and common resource manager, by which that selected information is processed, is identified by Common Resource Type ID of the common part.

The selected information has, in one example, version information in the common area, which enables the application to be prepared for an update of the application manager component. For example, when a notification of a USB event is enhanced by the update of an application manager component, such as adding the capability to filter information to be notified, new selected information would have a filter option of each App listed in the selected information and its version number is changed. When the application manager component is restarted, already running applications could be holding the USB selected information with an old version number, in which case, the application manager component can rebuild the usage information of that App as “No filter” as a default value. Other examples are possible.

The selected information has, in one example, a sequence index in the common area, which enables the application to be prepared for a scenario in which the common resource is accessed in prioritized order. For the case of prioritized order management, multiple applications maintain different contents of selected information at the same time. For example, assuming the access to the sound speaker is to be serialized, when high priority App-A gets an access right to the speaker first, App-A gets selected information which lists, e.g., “App-A/Using/High” and its sequence index is, e.g., 1. When low priority App-B requests access to the speaker next, App-B gets selected information which lists, e.g., “App-A/Using/High, App-B/Waiting/Low” and its sequence index is, e.g., 2. When medium priority App-C requests access to the speaker last, App-C gets selected information which lists, e.g., “App-A/Using/High, App-C/Waiting/Mid, App-B/Waiting/Low” and its sequence index is, e.g., 3. When the application manager component is restarted in this state, the application manager component obtains three different contexts of selected information from App-A, B and C. In such case, the application manager component checks the sequence number of the selected information, and generates rebuild information using the newest selected information, that is selected information from App-C.

In one example, selected information received by the application (e.g., application 210) is kept by the application side. In one example, an information holder (e.g., information holder 224) manages a repository for the selected information (e.g., information repository 226). The selected information currently used by the application is stored in the repository, and the information holder (e.g., information holder 224) provides service interfaces to add/remove information, as described herein. In one example, content of the selected information is unknown to the application(s). For instance, an application/application side component need not know the contents of the selected information. The selected information is just added, removed, obtained from the application (e.g., repository 226) but its contents are unknown to the application/application components performing the add, remove, obtain.

One example of information holder processing is described with reference to FIG. 6B. In one example, a process 650 executed by, e.g., an information holder (e.g., information holder 224) determines 652 whether an add of the selected information of the common resource to a repository (e.g., information repository 226) is to be performed. If the information is to be added to the repository, process 650 adds 654 the selected information for the requested common resource to the information repository (e.g., information repository 226) using, e.g., an add service interface. However, if it is not an add request but, instead, a remove request of selected information, then process 650 removes 656 selected information for the identified common resource from the information repository (e.g., information repository 226) using, e.g., a remove service interface.

Although there are multiple application programming interface handlers: one application programming interface handler per common resource, each application programming interface handler calls a service interface (e.g., the same service interface) of an information holder (e.g., information holder 224) to add the selected information to the repository when the selected information is received from the application manager component. In other embodiments, there may be more than one holder and/or service interface; many possibilities exist.

In one example, when a user performs an operation which releases the access to the common resource, relevant selected information for the common resource maintained in the application (e.g., in information repository 226) is removed, as described with reference to FIGS. 4A-4B and 6B. For instance, as described herein, based on the trigger from the user operation, the application programming interface handler for the relevant common resource is called from the application logic to end the resource access. The application programming interface handler calls a service interface of the information holder (e.g., information holder 224) to remove the related selected information from the repository (e.g., repository 226) and then sends a release request to the application manager component (e.g., application manager component 250). Again, although there are multiple application programming interface handlers: one application programming interface handler per common resource, in one example, each application programming interface handler calls a service interface (e.g., the same service interface) of an information holder (e.g., information holder 224) to remove the selected information from the repository. Other variations are possible.

In one example, even when the application manager component (application manager component 250) is stopped, applications continue to run and perform the selected information operations described herein, enabling the system to avoid state conflicts between the application manager component (e.g., application manager component 250) and the applications (e.g., application 210) during restart of the application manager component. When the application manager component is stopped, a connection between the application-side connection manager (e.g., app-side connection manager 228) and the application manager component-side connection manager (e.g., application manager component-side connection manager 266) is disconnected. When the resource is released, the application programming interface handler (e.g., application programming interface handler 222) for the common resource initiates removal of the selected information and attempts to send a release request to the application manager component in a manner similar to when the application manager component is running. However, the release request fails because the connection is disconnected. Therefore, in accordance with an aspect of the present invention, the application programming interface handler need not care about the failure of sending the release request because the related resource usage is rebuilt as “not using” by using the selected information later. The application programming interface handler replies “success” to the application logic (e.g., application logic 220) and the application logic stops using the resource as if the release request was sent to the application manager component successfully. Aspects of the release are described herein with respect to, e.g., FIG. 4B.

While the application manager component is stopped, in one example, new requests to obtain access are unenabled or in a wait state. When the application and application manager component are reconnected, the service becomes available immediately. In accordance with one or more aspects, because the rebuild procedure is lightweight, it can be considered that the information recovery time is not a burden to the total time to relaunch the application manager component. The application manager component is able to be relaunched quickly. As a convenience to the application logic, the application programming interface handler provides an option parameter to specify the wait time for an access request. The application programming interface handler, in one example, retries the access request until the specified wait time has ended.

In one example, when the application manager component is restarted, selected information in the system is sent to the application manager component, and the status of common resource usage is rebuilt.

The application-side connection manager (e.g., app-side connection manager 228) knows that the application manager component stopped by detecting a disconnection of the connection between the application and the application manager component. When a connection is lost, the application's connection manager (e.g., app-side connection manager 228) starts to try to reconnect with the application manager component. For example, a connect request is sent to the application manager component periodically until a success is replied from the application manager component. One example of this processing is described with reference to FIG. 7A.

Referring to FIG. 7A, in one example, a process 700 executing on an application-side connection manager (e.g., app-side connection manager 228) detects 710 a disconnection between application 210 and application component manager 250. Based on detecting the disconnection, process 700 obtains 712 an information list of the one or more common resources of the application (e.g., information for rebuilding common resources list) from an information holder (e.g., information holder 224). Further, process 700 sends 714 a connect request to an application manager component (e.g., application manager component 250). For instance, a connect request is sent from app-side connection manager 228 to application manager component-side connection manager 266. Process 700 determines 716 whether there was a connection. If not, processing returns to obtaining 712 the information.

In one example, as a parameter of a connection request, a selected information list stored in an information repository (e.g., information repository 226) is sent to the application manager component if that application is using one or more common resources. The application-side connection manager (e.g., app-side connection manager 228) obtains a selected information list via a service interface provided by an information holder (e.g., information holder 224). Since some selected information may be removed during reconnection if an application releases the related resource, the application-side connection manager (e.g., app-side connection manager 228) obtains a selected information list each time it attempts to send a connection request. An example of this processing is described with reference to FIG. 7A, described above, as well as FIG. 7C, described below.

Referring to FIG. 7C, in one example, a process 740 executed by, e.g., an information holder (e.g., information holder 224) generates 742 an information list for the one or more common resources of the application (e.g., information for rebuilding common resources list; selected information list) and returns it to the caller.

In one example, when an application and the application manager component are reconnected, an application manager component-side connection manager (e.g., application manager component-side connection manager 266) obtains the selected information from a connected application as a parameter of the connection request. When the application manager component-side connection manager obtains the selected information list, it sends the list to an information collector (e.g., information collector 264). The information collector has, for instance, a table which shows what common resource manager is responsible for a specific common resource. The information collector parses the list, checks the common resource type ID of the selected information, and sends the selected information to the corresponding common resource manager. One example of this processing is described with reference to FIG. 7D.

Referring to FIG. 7D, in one example, a process 750 executed by, e.g., an information collector (e.g., information collector 264) parses 752 an information list obtained by the application to determine the types of common resources. Process 750 sends 754 the selected information (e.g., rebuild information) regarding a particular common resource to the corresponding common resource manager (e.g., common resource manager 260).

In one example, when the selected information is sent to the common resource manager, the common resource manager performs a process for rebuilding the resource usage information, as described in one example with reference to FIG. 7B.

Referring to FIG. 7B, in one example, a process 730 executed by a common resource manager associated with the common resource (e.g., a common resource manager 260) receives 732 the selected information from the information collector (e.g., information collector 264) and rebuilds the common resource information (e.g., usage information of the common resource), as described herein. For instance, it uses the latest information, based on a sequencing index, to determine usage status and priority of its common resource for the one or more applications using the resource.

Described herein is one example of restart processing for an application manager component. This processing may be used for many types of use cases. Example use cases are provided below.

In one example, for a case of an access right control, only one set of selected information exists in the system. Therefore, when a common resource manager obtains the selected information, a rebuild of the common resource usage information can be completed immediately. Because the release request should come after the reconnection of that application, the release request can be handled immediately. The access request, though, is to wait, in one example, until the completion of the rebuild of a common resource usage information; however, it need not wait until all running applications are reconnected.

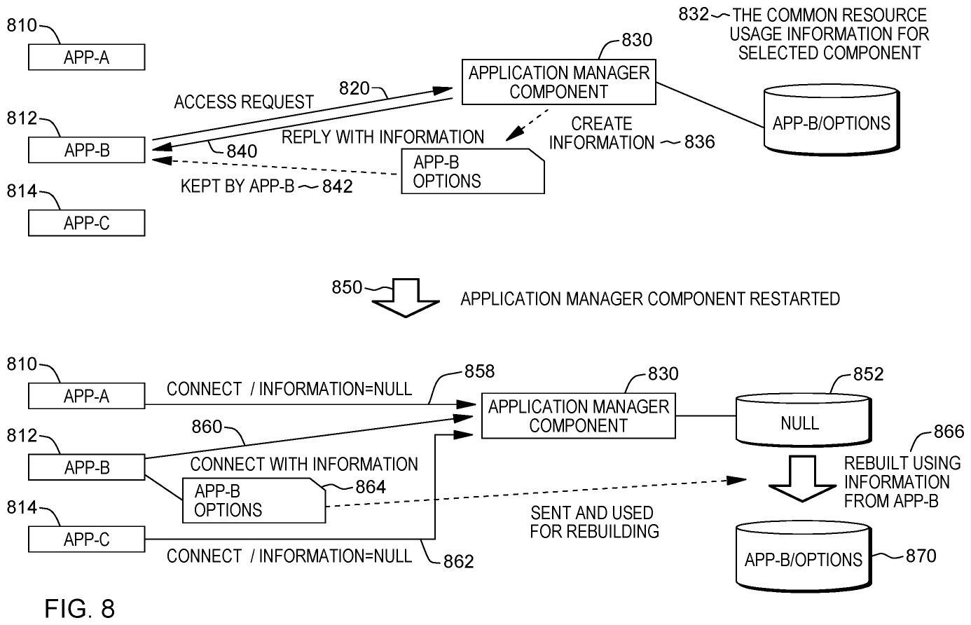

One example implementation of access right management is described with reference to FIG. 8. In this example, the common resource is a sound speaker; however, other common resources may be requested. In one example, when an application, App-B 812, sends 820 an access request to an application manager component (e.g., application manager component 830), application manager component 830 updates the usage information 832 of the common resource as “App-B using” with option parameter.

Further, application manager component 830 generates 836 information and sends 840 it back to App-B. The information includes, e.g., information about “App-B using” and its options.

App-B keeps 842 that information until App-B 812 completes use of the common resource.

In this case, only one App can access the common resource at a time in the system. If App-A tries to access the common resource, it is rejected.

When application manager component 830 is stopped and restarted 850, the usage information becomes null 852. Apps (A, B and C) 810, 812, 814 reconnect 858, 860, 862 to application manager component 830 when application manager component 830 is restarted 850.

Information 864 is sent from App-B 812 as the parameter of the connect request 860. Application manager component 830 uses it to rebuild 866 the usage information 870. Other Apps (A and C) do not send information because they are not using the selected component.

The order of reconnection is different each time. Application manager component 830 can handle rebuild immediately when it receives the information from App-B.

If App-B completes use of the common resource while application manager component 830 is stopped, the information is not sent from App-B. Therefore, the usage status is rebuilt as null which means “No access from any App”. That is an expected status of the system.

Another implementation case relates to notification control. Although multiple sets of information (e.g., information for rebuilding common resources) may exist in the system, the sets of information do not depend on each other. Therefore, both release and access requests can be handled (e.g., immediately) even while the common resource manager is rebuilding the usage information. When a release request is sent, because the information of a corresponding part of the usage information had already been rebuilt at reconnection, the common resource manager can remove it from the usage information. The access request, that is registering notification listening, is sent from the application which had no access to the resource before the application manager component's stop, therefore, it can be registered as a new notification listener (e.g., immediately).

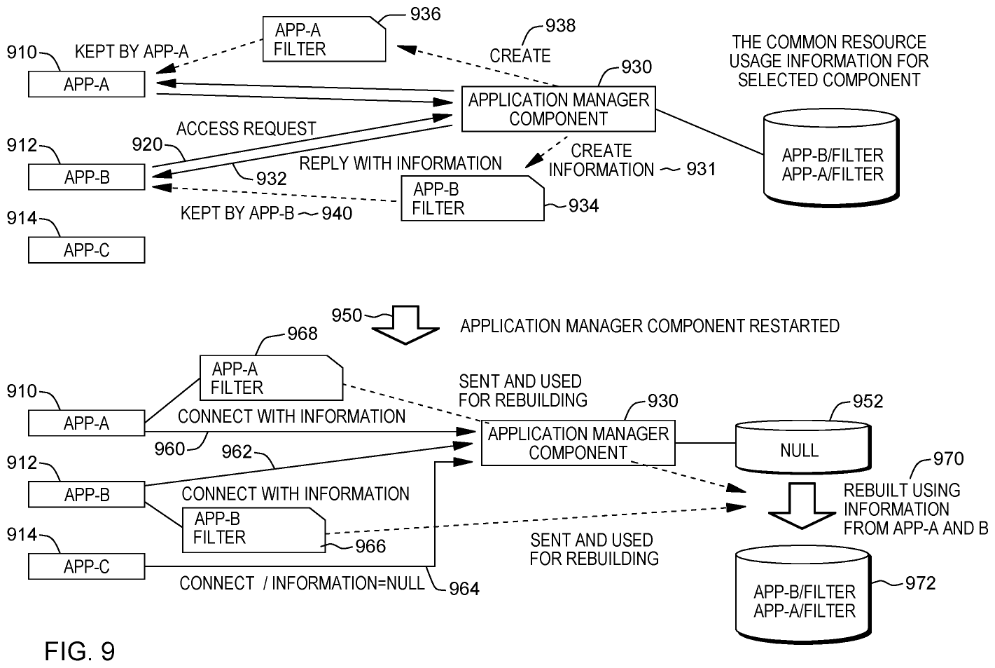

One example implementation of notification management is described with reference to FIG. 9. In this example, the common resource is a universal serial bus; however, other common resources may be used. In one example, when an application, App-B 912, sends 920 an access request to an application manager component (e.g., application manager component 930), application manager component 930 registers App-B as the listener of the common resource.

Further, application manager component 930 generates 931 information and sends 932 it back to App-B. The information 934 includes, e.g., information about “App-B using” and its filter options (e.g., items to be notified). App-B keeps 940 that information until App-B completes use of the common resource. After that, when status of the common resource is changed, application manager component 930 sends the notification to App-B.

Other apps, that is App-A 910, also can access information 936 at this time. When App-A accesses the common resource, information 936 for App-A is generated 938 as the same as the case of App-B.

When application manager component 930 is stopped and restarted 950, the usage information of the common resource becomes null 952.

Apps (A, B and C) 910, 912, 914 reconnect 960, 962, 964 to the application manager component when application manager component 930 is restarted.

Information 966, 968, respectively, is sent from App-B 912 and App-A 910 as a parameter of the connect request 962, 960 since they are using the common resource, and application manager component 930 uses that to rebuild 970 usage information 972. App-C 914, which is not using the common resource, does not send information.

The order of reconnection is different each time. Application manager component 930, in one example, adds an application (App) as a listener immediately when it receives information from the App (e.g., App-B and App-A).

In this case, an application can make an access request of the common resource when the usage information is rebuilt. For example, even when App-C makes an access request before App-A's reconnection, application manager component 930 can add App-C as a new listener.

Another implementation case relates to priority order control. In this case, it is to wait for the completion of a rebuild of common resource usage information to handle release and access requests; however, the wait time will be an acceptable short amount of time (e.g., in one example, less than hundreds of milliseconds; or another amount of acceptable time in other embodiments; various amounts of times or ranges of times may be deemed acceptable).

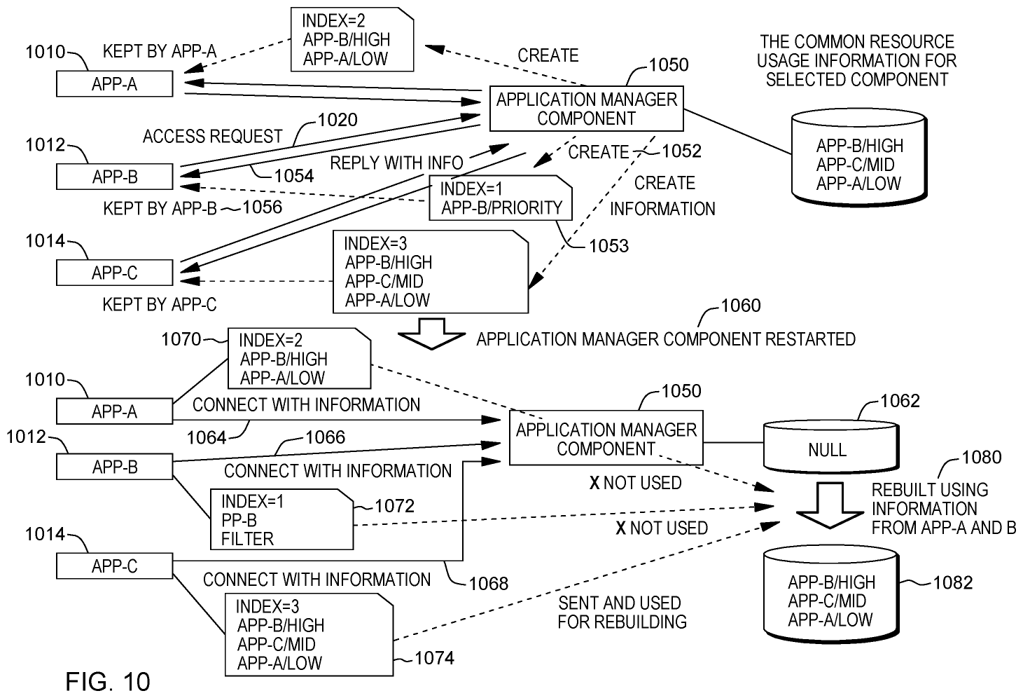

One example implementation of priority order management is described with reference to FIG. 10. In this example, the common resource is an interrupt screen; however, other common resources may be used. In one example, when an application, App-B 1012, sends 1020 an access request to an application manager component (e.g., application manager component 1050), application manager component 1050 allows App-B to show the common resource (e.g., interrupt screen).

Further, application manager component 1050 generates 1052 information 1053 and sends 1054 it back to App-B. The information includes, e.g., information about “App-B is showing”, priority (High) and sequence index (1).

App-B keeps 1056 that information until App-B completes the showing of the interrupt screen.

Other Apps, e.g., App-A 1010 and App-C 1014, also can request the interrupt screen. App-A, which makes the request next, waits until after App-B, because its priority is, e.g., lower than App-B.

When App-C requests the interrupt screen, it waits. Though App-C makes a request after App-A, the waiting order becomes faster than App-A because its priority is, e.g., higher (Mid).

At this time, three different contents of information exist in the system.

When application manager component 1050 is stopped and restarted 1060, the usage information of the interrupt screen becomes null 1062.

Apps (A, B and C) reconnect 1064, 1066, 1068 to application manager component 1050 when the application manager component is restarted.

Information 1070, 1072, 1074 is sent from App-A 1010, B 1012 and C 1014 with each connect request 1064, 1066, 1068, respectively, and application manager component 1050 uses the information to rebuild 1080 the usage information 1082.

The order of reconnection is different each time. Until all apps are connected, application manager component 1050 checks the sequence index information to determine what information is the latest. In this example, application manager component 1050 determines to use information from App-C, which has a sequence index that is the largest compared to App-A and App-B.

If App-A had canceled use of the interrupt screen during restart of application manager component 1050, the information does not come from App-A. In that case, application manager component 1050 rebuilds the usage information with removing data for App-A.

Although various use cases are provided as examples, many other use cases and/or examples are possible.

Described herein are embodiments of facilitating processing in a computing environment with respect to, for instance, restarting an application manager component. One or more aspects provide a lightweight technique to generate information used to rebuild common resource management information at a restart of an application manager component. In one example, the format and the information are kept in the application side, and the lightweight technique keeps applications running while the application manager component is stopping so that information stored in the application side is kept consistent to system state changes. The lightweight technique is to rebuild the resource usage status of the application manager component by using the information kept in the application side at the application manager component's restart.

One or more aspects are applied to an application management system working on an edge device in which available memory is limited. In such a system, an application is running under the common resource management of an application manager component. Also, each application and the application manager component keeping connection, exchange commands and event notifications.

A common resource covered by one or more aspects is the edge device's sub-functional device(s) and software service(s) (e.g., universal serial bus, network adapter, sound speaker, microphone, camera, user monitoring device, drawing window for display, voice recognition system, etc.). In one or more aspects, the application manager component manages the access right to the common resource. For example, the application manager component assigns the access right of, e.g., an in-vehicle microphone to one application at a time. The application manager component manages notification of the event on the common resource. For example, the application manager component makes notifications about insertion/removal of, e.g., a universal serial bus to the application which registers the event notification listener to the application manager component. The application manager component manages the prioritized order for using the common resource. For example, on, e.g., a navigation system, an application's small screen (called an interrupt screen) is overlayed on the map view screen. Because the screen size of the navigation system is not large enough, a multiple number of interrupt screens are stacked in layers and the top layer (which is displayed) is switched via user action. The application manager component keeps the information about such ordering of screen layers, that is, interrupt screens are toggled by the order of, e.g., App-C, App-A and App-D. Other examples are possible.

To make it work even in an environment with a small memory, one or more aspects need not run a duplicate backup system as stand-by. The rebuild of resource management information is done by collaboration of, e.g., small components implemented in one application manager component and running applications only.

In one example, the information which is used to rebuild a common resource management information is called information for rebuilding common resources or selected information herein.

When an application sends a request to access a common resource to the application manager component, the application manager component sends back a response with the selected information. Applications just keep the information while the application is using that common resource. By keeping the selected information on the running application side, the information about which applications are accessing the common resource is kept in the system even when the application manager component is stopped.

By keeping the selected information on the application side, it is possible to reflect a change in the application's resource usage condition in real time by the application side, that is, when the application is no longer using the common resource, the application discards the selected information for that resource. When an application which is using the common resource is terminated while the application manager component restarts, the selected information kept by that application is automatically discarded. Therefore, it is possible to continue to run the application and use already allowed common resources until it becomes unnecessary during the application manager component's restart without considering status mismatch due to the termination of resource use.

When the application manager component and the applications are reconnected after the application manager component's restart, the selected information is sent back to the application manager component from the running applications if they (the applications) have the selected information. The application manager component then rebuilds the common resource usage status by using the selected information. By sending the latest selected information (which reflects the real time common resource usage status of each application) from running applications to the restarted application manager component, it is possible to reflect real time system status to the rebuilt common resource usage status inside the restarted application manager component.

For, e.g., a case of supporting the prioritized order of resource usage, the selected information can be sent to multiple applications which requested access to the same common resource. To support such case, the selected information has information to identify when that selected information is generated. By referring to that information, the application manager component can choose the newest selected information only or can use the selected information sequentially when the application manager component rebuilds the common resource usage information.

During the time in which the application manager component restarts (e.g., a few seconds or other amount of time), new requests to access the common resource may be unenabled or have to wait especially for the case of managing priority order. For that case, the function to select unenabled or wait is provided.

One or more aspects provide a capability to shut down the application manager component even for an update, without negotiating its absence with the applications before shutdown. Therefore, with one or more aspects, the application manager component can be intentionally stopped and restarted anytime for any purpose (e.g., updates, maintenance, etc.) and its restart works, in one example, as described herein.

In one or more aspects, an application manager component executing on a device obtains a request from an application to use a resource common to a plurality of applications. Based on obtaining the request, information to be used to rebuild status of the resource should it be determined that status rebuild of the resource is to be performed, is provided to the application. The application manager component obtains, based on a restart of the application manager component, the information to be used to rebuild the status of the resource. The information is used to rebuild the status of the resource.

By providing the information to the application, the information remains available should there be a need for a rebuild of status relating to the information, such as based on a restart of the application manager component. This facilitates processing and minimizes the use of memory by enabling the rebuild without requiring additional resources, such as duplicate systems.

In one example, the information includes an identifier of the resource and usage information of the resource by the application. This information facilitates a rebuild of usage status of the resource. In one example, the information includes control data of the resource. The control data provides unique aspects of the resource for a particular application and facilitates a rebuild of usage status of the resource.

In one embodiment, based on the providing to the application the information, the information is stored in a repository of the application. By storing the information in the repository, the information is available to rebuild resource status. It enables applications to continue to run even if the application manager component stops and/or is restarted. This facilitates processing and minimizes the use of redundant resources.

In one embodiment, the obtaining by the application manager component the information to be used to rebuild the status of the resource includes obtaining the information based on a connect request of the application to the application manager component. If the application manager component stops or disconnects from the application, the application may request to connect and based thereon, provides the information to the application manager component enabling that component to rebuild status of the resource. This allows applications to continue running even if the application manager component stops and/or is restarted.

In one embodiment, the obtaining by the application manager component the request includes using an application manager component-side connection manager of the application manager component coupled to an application-side connection manager of the application to obtain the request from the application. This facilitates communication between the application and the application manager component.

In one example, the device is an edge device providing a function to a user, and the resource is related to the function. This allows processing to be performed close to the data and without requiring a large amount of resources.

In one embodiment, the content of the information is unknown to the application. Thus, the application is not responsible for understanding the content but yet is able to facilitate processing by storing the information and then providing the information to the application manager component for rebuilding status of the resource.

In one aspect, a request to use a resource common to a plurality of applications is sent from an application executing on a device to an application manager component. Based on sending the request, the application obtains access to the resource and information relating to the resource. A determination is made that the application manager component has been restarted. Based on determining that the application manager component has been restarted, the information is provided to the application manager component. The information is to be used to rebuild status of the resource. By obtaining the information and providing it to the application manager component, a rebuild of resource status is enabled. This allows the application to continue running even if the application manager component stops and/or is restarted.

In one embodiment, the information is stored in a repository of the application based on obtaining the information. This enables the application to hold the information in case it is needed by the application manager component for a rebuild of resource status.

In one embodiment, the application continues to run, based on a stopping of the application manager component. This facilitates processing by not disrupting the running of the application.

In one embodiment, the information held by the application is removed, based on termination of use of the resource by the application. This enables resources to be returned to the application and reduces the amount of memory or storage used to hold the information.

Although various examples are provided herein, other examples/embodiments are possible. For instance, other common resources may be used. Further, there may be additional, fewer and/or other common resource managers. In other examples, there may be, for instance, one common resource manager for a plurality of common resources. Other examples also exist. Other aspects, variations and/or embodiments are possible.

Additionally, although an application is described herein as having certain components, one or more of the components may be included within the application and/or be of the application (e.g., external to the application (e.g., application code), but managed as part of the application). Further, application and application side may be used interchangeably herein. Various implementations are possible. This is also true for the application manager component in which one or more components of the application manager component may be included within and/or be of the application manager component (e.g., external to the application manager component but managed as part of the application manager component). Further, application manager component and application manager component side may be used interchangeably herein. Again, various implementations are possible.

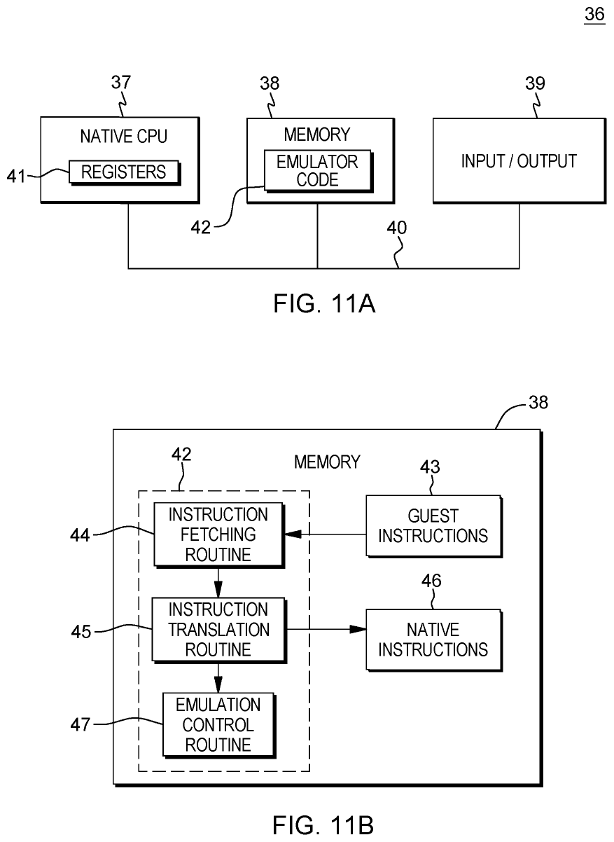

Further, although one or more examples of a computing environment to incorporate and use one or more aspects of the present invention are described herein, FIGS. 11A-11B depict another embodiment of a computing environment to incorporate and use one or more aspects of the present invention.

Referring, initially, to FIG. 11A, in this example, a computing environment 36 includes, for instance, a native central processing unit (CPU) 37 based on one architecture having one instruction set architecture, a memory 38, and one or more input/output devices and/or interfaces 39 coupled to one another via, for example, one or more buses 40 and/or other connections.

Native central processing unit 37 includes one or more native registers 41, such as one or more general purpose registers and/or one or more special purpose registers used during processing within the environment. These registers include information that represents the state of the environment at any particular point in time.

Moreover, native central processing unit 37 executes instructions and code that are stored in memory 38. In one particular example, the central processing unit executes emulator code 42 stored in memory 38. This code enables the computing environment configured in one architecture to emulate another architecture (different from the one architecture) and to execute software and instructions developed based on the other architecture.

Further details relating to emulator code 42 are described with reference to FIG. 11B. Guest instructions 43 stored in memory 38 comprise software instructions (e.g., correlating to machine instructions) that were developed to be executed in an architecture other than that of native CPU 37. For example, guest instructions 43 may have been designed to execute on a processor based on the other instruction set architecture, but instead, are being emulated on native CPU 37, which may be, for example, the one instruction set architecture. In one example, emulator code 42 includes an instruction fetching routine 44 to obtain one or more guest instructions 43 from memory 38, and to optionally provide local buffering for the instructions obtained. It also includes an instruction translation routine 45 to determine the type of guest instruction that has been obtained and to translate the guest instruction into one or more corresponding native instructions 46. This translation includes, for instance, identifying the function to be performed by the guest instruction and choosing the native instruction(s) to perform that function.

Further, emulator code 42 includes an emulation control routine 47 to cause the native instructions to be executed. Emulation control routine 47 may cause native CPU 37 to execute a routine of native instructions that emulate one or more previously obtained guest instructions and, at the conclusion of such execution, return control to the instruction fetch routine to emulate the obtaining of the next guest instruction or a group of guest instructions. Execution of the native instructions 46 may include loading data into a register from memory 38; storing data back to memory from a register; or performing some type of arithmetic or logic operation, as determined by the translation routine.

Each routine is, for instance, implemented in software, which is stored in memory and executed by native central processing unit 37. In other examples, one or more of the routines or operations are implemented in firmware, hardware, software or some combination thereof. The registers of the emulated processor may be emulated using registers 41 of the native CPU or by using locations in memory 38. In embodiments, guest instructions 43, native instructions 46 and emulator code 42 may reside in the same memory or may be disbursed among different memory devices.

The computing environments described herein are only examples of computing environments that can be used. One or more aspects of the present invention are tied to computer technology and facilitate processing within a computer, improving performance thereof. For instance, processing is facilitated by allowing applications to continue to run even if the application manager component is stopped and/or restarted. This increases throughput and minimizes disruptions. Further, the use of additional resources is avoided by using a technique that does not require a duplicate system. The use of memory/storage for the selected information is minimized by removing the selected information that is no longer used by the application. Processing within a processor, computer system and/or computing environment is improved.

Other aspects, variations and/or embodiments are possible.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

Yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other edge devices, application components and/or application manager components may be used. Further, variations to the processing may be performed without departing from one or more aspects of the present invention. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of facilitating processing within a computing environment, the computer-implemented method comprising:
obtaining, by an application manager component executing on a device, a request from an application to use a resource common to a plurality of applications;
providing to the application, based on obtaining the request, information to be used to rebuild status of the resource should it be determined that status rebuild of the resource is to be performed;
obtaining, by the application manager component based on a restart of the application manager component, the information to be used to rebuild the status of the resource; and
using the information to rebuild the status of the resource.

2. The computer-implemented method of claim 1, wherein the information includes an identifier of the resource and usage information of the resource by the application.

3. The computer-implemented method of claim 1, wherein the information includes control data of the resource.

4. The computer-implemented method of claim 1, wherein based on the providing to the application the information, the information is stored in a repository of the application.

5. The computer-implemented method of claim 1, wherein the obtaining by the application manager component the information to be used to rebuild the status of the resource comprises obtaining the information based on a connect request of the application to the application manager component.

6. The computer-implemented method of claim 1, wherein the obtaining by the application manager component the request comprises using an application manager component-side connection manager of the application manager component coupled to an application-side connection manager of the application to obtain the request from the application.

7. The computer-implemented method of claim 1, wherein the device is an edge device providing a function to a user, and the resource is related to the function.

8. The computer-implemented method of claim 1, wherein content of the information is unknown to the application.

9. A computer system for facilitating processing within a computing environment, the computer system comprising:
a device configured to perform a method, said method comprising:
obtaining, by an application manager component executing on the device, a request from an application to use a resource common to a plurality of applications;
providing to the application, based on obtaining the request, information to be used to rebuild status of the resource should it be determined that status rebuild of the resource is to be performed;
obtaining, by the application manager component based on a restart of the application manager component, the information to be used to rebuild the status of the resource; and
using the information to rebuild the status of the resource.

10. The computer system of claim 9, wherein based on the providing to the application the information, the information is stored in a repository of the application.

11. The computer system of claim 9, wherein the obtaining by the application manager component the information to be used to rebuild the status of the resource comprises obtaining the information based on a connect request of the application to the application manager component.

12. The computer system of claim 9, wherein the obtaining by the application manager component the request comprises using an application manager component-side connection manager of the application manager component coupled to an application-side connection manager of the application to obtain the request from the application.

13. The computer system of claim 9, wherein the device is an edge device providing a function to a user, and the resource is related to the function.

14. A computer program product for facilitating processing within a computing environment, the computer program product comprising:
one or more computer readable storage media and program instructions collectively stored on the one or more computer readable storage media to perform a method comprising:
obtaining, by an application manager component executing on a device, a request from an application to use a resource common to a plurality of applications;
providing to the application, based on obtaining the request, information to be used to rebuild status of the resource should it be determined that status rebuild of the resource is to be performed;
obtaining, by the application manager component based on a restart of the application manager component, the information to be used to rebuild the status of the resource; and
using the information to rebuild the status of the resource.

15. The computer program product of claim 14, wherein based on the providing to the application the information, the information is stored in a repository of the application.

16. The computer program product of claim 14, wherein the obtaining by the application manager component the information to be used to rebuild the status of the resource comprises obtaining the information based on a connect request of the application to the application manager component.

17. The computer program product of claim 14, wherein the obtaining by the application manager component the request comprises using an application manager component-side connection manager of the application manager component coupled to an application-side connection manager of the application to obtain the request from the application.

18. A computer-implemented method of facilitating processing within a computing environment, the computer-implemented method comprising:
sending, from an application executing on a device, a request to an application manager component to use a resource common to a plurality of applications;
obtaining by the application, based on sending the request, access to the resource and information relating to the resource;
determining that the application manager component has been restarted; and
providing, based on determining that the application manager component has been restarted, the information to the application manager component, wherein the information is to be used to rebuild status of the resource.

19. The computer-implemented method of claim 18, further comprising storing the information in a repository of the application based on obtaining the information.

20. The computer-implemented method of claim 18, further comprising continuing to run the application, based on a stopping of the application manager component.

21. The computer-implemented method of claim 18, further comprising removing the information held by the application, based on termination of use of the resource by the application.

22. A computer program product for facilitating processing within a computing environment, the computer program product comprising:
one or more computer readable storage media and program instructions collectively stored on the one or more computer readable storage media to perform a method comprising:
sending, from an application executing on a device, a request to an application manager component to use a resource common to a plurality of applications;
obtaining by the application, based on sending the request, access to the resource and information relating to the resource;
determining that the application manager component has been restarted; and
providing, based on determining that the application manager component has been restarted, the information to the application manager component, wherein the information is to be used to rebuild status of the resource.

23. The computer program product of claim 22, wherein the method further comprises storing the information in a repository of the application based on obtaining the information.

24. The computer program product of claim 22, wherein the method further comprises continuing to run the application, based on a stopping of the application manager component.

25. The computer program product of claim 22, wherein the method further comprises removing the information held by the application, based on termination of use of the resource by the application.
